(19) United States
(12) Patent Application Publication
(10) Pub. No.: US 2014/0331190 A1
(43) Pub. Date: Nov. 6, 2014

(54) NON-STRAIGHT GESTURE RECOGNITION METHOD FOR TOUCH DEVICES

(71) Applicants: You He CHANG, Taoyuan County (TW); Well King Technology Co.,Ltd, Taoyuan County (TW)

(72) Inventor: You He CHANG, Taoyuan County (TW)

(73) Assignees: You He CHANG, Taoyuan County (TW); WELL KING TECHNOLOGY CO.,LTD, Taoyuan County (TW)

(21) Appl. No.: 14/268,472

(22) Filed: May 2, 2014

(30) Foreign Application Priority Data
May 6, 2013 (TW) 102116030

(51) Int. Cl. G06F 3/01; G06F 3/0484; G06F 3/0488

(52) U.S. Cl. CPC G06F 3/017; G06F 3/0488; G06F 3/0484
USPC 715/863

(57) ABSTRACT

A non-straight gesture recognition method is used for a touch device which includes a touch display panel and a data processing module. The method comprises: a user draws on the touch display panel to form a non-straight line locus; next, the data processing module registers a movement time from the non-straight line locus and captures a plurality of locus points to establish a locus equation to calculate a first-order differential value and a quadratic differential value; finally the data processing module judges a locus configuration of the non-straight line locus based on the movement time, first-order differential value and quadratic differential value and orders the multi-touch device to execute a preset program corresponding to the locus configuration. The non-straight line locus can be formed in various types of locus configurations to activate different types of corresponding preset programs, and also reduce user's erroneous operation.

### FIELD OF THE INVENTION

The present invention relates to a gesture recognition method for touch device and particularly to a non-straight gesture recognition method for touch devices.

### BACKGROUND OF THE INVENTION

Portable electronic devices are very popular nowadays. Their executable programs or functions increase greatly, and their operation interface also has received a lot of attention. Since touch screen makes design of the operation interface much neater and simpler, and allows users to do operation in a more intuitive and efficient way, it is now widely adopted on all types of portable electronic device. Moreover, touch control device capable of detecting user's hand gestures also has been developed. This also once again makes it a hot focus in the industry.

U.S. patent publication No. US2009/0160804 discloses an electronic device control method and devices using this method and recoding media. Its control method first detects a movement on a touch induction module and generates a detection signal corresponding to the movement, then controls operation of the electronic device based on the detected signal. Its main features: when the detection signal judges that the movement speed does not exceed a critical velocity, the electronic device is ordered to execute a first preset program; and when the detection signal judges that the movement speed exceeds the critical velocity, the electronic device is ordered to execute a second preset program different from the first preset program. Hence depending on the movement speed users can operate the electronic device to execute different preset programs.

Due to the aforesaid control method makes the electronic device to execute different programs according to different movement speeds, but the general users often cannot precisely judge the movement speed and do operation accordingly, that could easily cause erroneous operation. Moreover, asking the general users to make movement in various speeds to activate different programs has substantial difficulty in practice, and the number of programs that can be activated also is limited. All this indicates that there is still room for improvement.

### SUMMARY OF THE INVENTION

The primary object of the present invention is to solve the problems of conventional method of controlling operation of electronic devices through movement speed that are difficult to control movement speed, easily cause erroneous operation and provide only a limited number of function commands to mate the programs that can be activated.

To achieve the foregoing object, the present invention provides a non-straight gesture recognition method applicable on a touch device which includes a touch display panel and a data processing module electrically connected to the touch display panel. The method comprises the steps as follows:

Step S1: A user touches the touch display panel and draws thereon to form a non-straight line locus;

Step S2: The data processing module detects the non-straight line locus and registers a movement time from the non-straight line locus, and captures a plurality of locus points to establish a locus equation to calculate a first-order differential value and a quadratic differential value; and

Step S3: The data processing module judges a locus configuration of the non-straight line locus based on the movement time, first-order differential value and quadratic differential value and orders the multi-touch device to activate a preset program corresponding to the locus configuration.

Thus, through the data processing module to detect the non-straight line locus, register the movement time of the non-straight line locus and get the first-order differential value and quadratic differential value to judge the locus configuration of the non-straight line locus, many advantages can be attained, notably:

1. The non-straight line locus can be formed in many types of locus configurations corresponding to many different preset programs to be activated, hence increase user's choices and applications in terms of the touch control locus configurations.

2. From user's perspective, the non-straight line locus is a geometric graphic and can be differentiated easily and quickly, hence can reduce erroneous operation.

3. By using the first-order differential value and quadratic differential value, compared with the conventional calculation method, it can save usage of memory of the touch device and facilitate further development in the industry.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a process flowchart of the invention.

FIG. 2 is a structural block diagram of the invention.

FIG. 3 is a schematic view of an embodiment of a non-straight line locus according to the invention.

### DETAILED DESCRIPTION OF THE PREFERRED EMBODIMENT

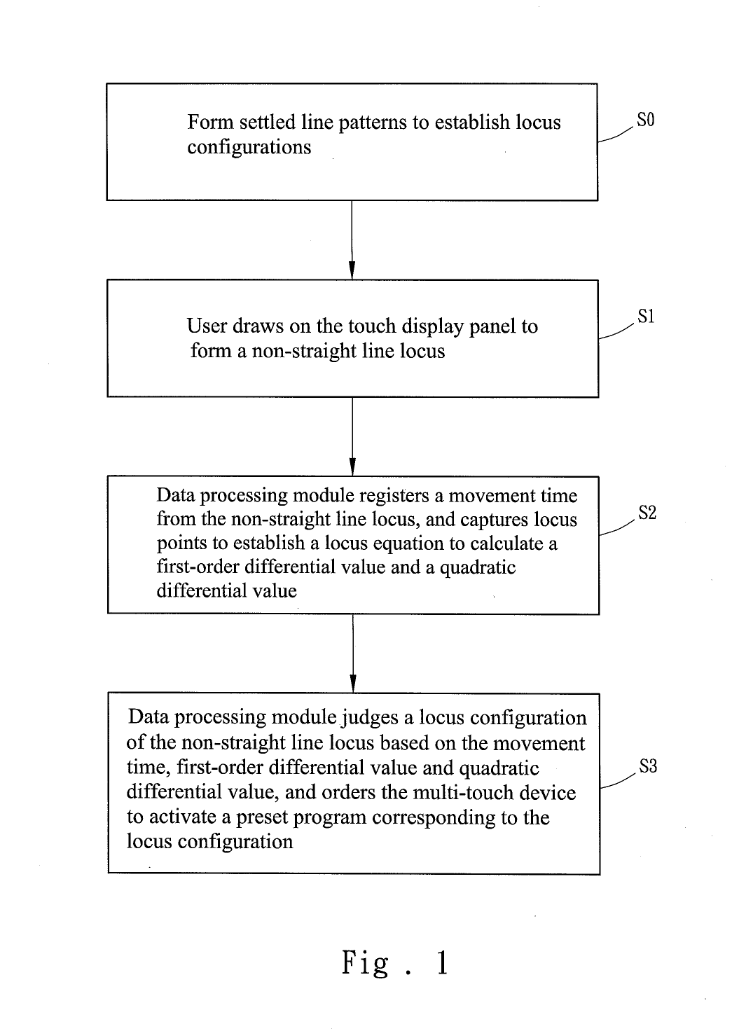

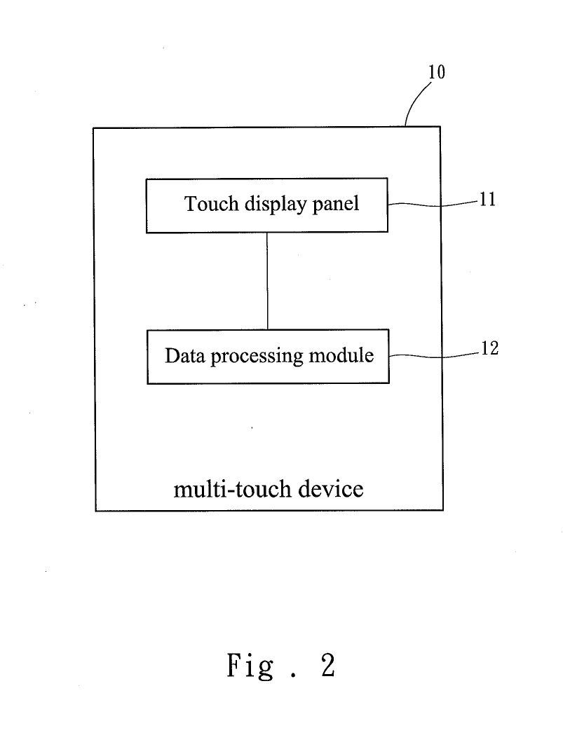

Please refer to FIGS. 1, 2 and 3, the present invention aims to provide a non-straight gesture recognition method for touch devices. Specifically, the touch devices of the present invention is a multi-touch device 10 which includes a touch display panel 11 and a data processing module 12 electrically connected to the touch display panel 11. The non-straight gesture recognition method comprises the steps as follows:

Step S1: A user touches the touch display panel 11 and draws thereon to form a non-straight line locus 20; the non-straight line locus 20 can be a continuous curve or a non-continuous curve drawn by the user by freely drawing on the touch display panel 11, such as drawing a finger on the touch display panel 11 for a duration between 0 and 0.5 second, and leaving the touch display panel 11 at the instant moment of 0.5 second, then putting the finger onto the touch display panel 11 again at the time of 0.65 second to finish the non-straight line locus 20, which becomes a non-continuous curve. If the user's finger leaves the touch display panel 11 at the time of 0.5 second and does not make contact on the touch display panel 11 again for a set waiting duration such as 0.2 second, and does not contact the touch display panel 11 within a duration of 0.7 second, the non-straight line locus 20 becomes a continuous curve;

Step S2: The data processing module 12 detects the non-straight line locus 20, and registers a movement time from the non-straight line locus 20, and captures a plurality of locus points 21 to establish a locus equation to calculate a first-order differential value and a quadratic differential value. In this embodiment the movement time means the duration of user's finger drawing on the touch display panel 11 until the non-straight line locus 20 is finished, usually between 0.3 second and 0.6 second, but this is not the limitation. The data processing module 12 captures the locus points 21 which include a start point 211 and an end point 212, and establishes a locus equation through the locus points 21, and performs a calculation to get the first-order differential value and quadratic differential value. For instance, the locus equation can be f(x)=x²+4; the first-order differential equation value can be obtained via the first-order differential equation r(x)=2x of the locus equation, and the quadratic differential value can be obtained via the quadratic differential equation f″(x)=2 of the locus equation; and

Step S3: The data processing module 12 judges a locus configuration of the non-straight line locus 20 based on the movement time, first-order differential value and quadratic differential value, and orders the multi-touch device 10 to execute a preset program corresponding to the locus configuration. Based on the movement time, first-order differential value and quadratic differential value that form a trend on the non-straight line locus 20, the data processing module 12 can get a pole, gradient, gradient increase or decrease trend or amount and the like, thereby judge the locus configuration of the non-straight line locus 20, such as, but not limited to, a curve with concave upwardly, a curve with concave downwardly, or a curve with an inflection point, or the like. Furthermore, based on the characteristics of the locus configuration, such as the concave opening size, curvature, pole and the like, the type of the non-straight line locus 20 can be further divided to make different locus configurations corresponding to different preset programs, until an executable program is mated. The preset programs can be used to open a Web page, a document, an application program, or set a password by the locus configuration formed by the non-straight line locus 20 to access protected data, or control a touch induced lock. This invention can also include another step SO before the step S1. At step S0 the user first draws on the touch display panel 11 to form a settled line pattern. The data processing module 12 registers the movement time, first-order differential value and quadratic differential value of the settled line pattern to establish the locus configuration thereof. Then the user sets the required executable preset programs on the multi-touch device 10 corresponding to the locus configuration. Thus, at step S3, when the data processing module 12 judges the locus configuration of the non-straight line locus 20 based on the movement time, first-order differential value and quadratic differential value, it can order the multi-touch device 10 to execute the corresponding preset program, therefore the user can draw the settled line pattern to set the corresponding executable preset program according to his/her preference.

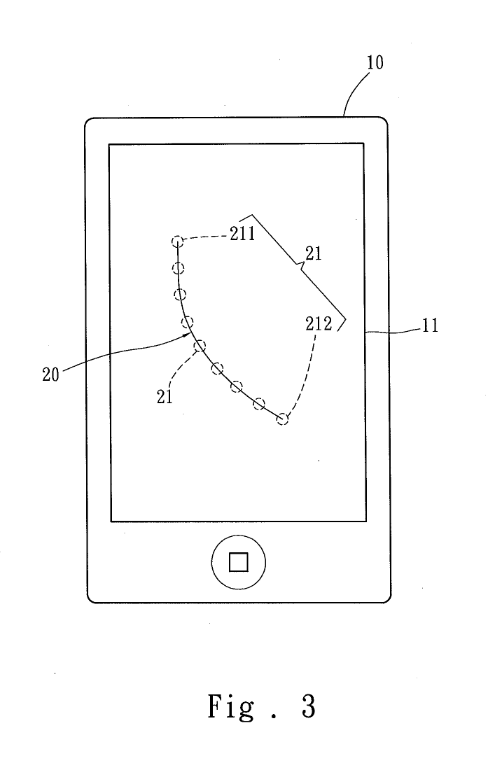

Please refer to FIG. 3 again, it is to be noted that in this embodiment on the settled process, the user first establish the locus configuration via the settled line pattern made according to a first curve which has the first start point 211 and first end point 212, and from the first start point 211 to the first end point 212 the first-order differential value and quadratic differential value decrease gradually. At step S1, the user draws on the touch display panel 11 to form the non-straight line locus 20, and the data processing module 12 captures multiple locus points 21 to establish the locus equation, and also gets the start point 211 and end point 211 from the locus points 21, then judges the locus configuration being the first curve via the locus equation which provides the first-order differential value gradually decreased from the start point 211 to the end point 212, and the quadratic differential value which also gradually decreases from the start point 211 to the end point 212, based on which the multi-touch device 10 can execute a first preset program corresponding to the first curve.

Similarly, the user can set a second curve, a third curve and a fourth curve based on the movement time, first-order differential value and quadratic differential value to mate and activate respectively a second preset program, a third preset program and a fourth preset program and the like. For instance, the second curve can have a gradually increased first-order differential value and gradually decreased quadratic differential value from a second start point 211 to a second end point 212; the third curve can have a gradually increased first-order differential value and gradually increased quadratic differential value from a third start point 211 to a third end point 212; and the fourth curve can have a gradually decreased first-order differential value and gradually increased quadratic differential value from a fourth start point 211 to a fourth end point 212; thus the data processing module 12 can judge via the locus equation established based on the non-straight line locus 20 whether the movement time, first-order differential value and quadratic differential value are presented corresponding to the second curve, third curve or fourth curve from the start point 211 to the end point 212.

It is to be noted that the embodiments set forth above are elaborated merely based on the locus configurations established according to the first curve, second curve, third curve and fourth curve, but they are not the limitation of the invention. The locus configuration can also be formed in other fashions, such as a curve with concave upwardly, a curve with concave downwardly, a curve with an inflection point and the like, and can be freely established by the user. The non-straight line locus 20 can also be non-continuous, thus the user can establish the locus configuration with unique features and more privacy.

As a conclusion, the invention employs the data processing module to detect the non-straight line locus, and through registering the movement time, first-order differential value and quadratic differential value of the non-straight line locus, judges the locus configuration of the non-straight line locus. The invention thus formed provides many advantages, notably:

1. The non-straight line locus can be formed in many types of configurations corresponding to many different preset programs to be activated.

2. From user's perspective, the non-straight line locus is a geometric graphic and can be differentiated easily and quickly, hence can reduce erroneous operation.

3. The invention performs judgment through the registered movement time, and first-order differential value and quadratic differential value, compared with the conventional techniques of registering in a cluster or matrix. The method of the invention can decrease the usage of memory of the touch device with faster speed and higher performance.

4. Compared with the conventional operation methods of vertical or horizontal drawing, the invention of the non-straight line locus is more ergonomic to reduce injury of user's wrist when using the multi-touch devices for a long time.

5. The locus configuration formed via the non-straight line locus can be set as a password to access protected private data, and the password can be personalized and provide greater privacy to improve protection.

All this indicates that the present invention provides significant improvements over the conventional techniques.

What is claimed is:

1. A non-straight gesture recognition method for a touch device which includes a touch display panel and a data processing module electrically connected to the touch display panel, the method comprising the steps of:
Step S1: touching the touch display panel by a user and drawing on the touch display panel to form a non-straight line locus;
Step S2: detecting the non-straight line locus by the data processing module and registering a movement time from the non-straight line locus, and capturing a plurality of locus points to establish a locus equation to calculate a first-order differential value and a quadratic differential value; and
Step S3: judging by the data processing module a locus configuration of the non-straight line locus based on the movement time, the first-order differential value and the quadratic differential value and ordering the touch device to execute a preset program corresponding to the locus configuration.

2. The method of claim 1, wherein at Step 2 the data processing module gets a start point and an end point from the locus points according to the movement time.

3. The method of claim 2, wherein at Step 3 the locus equation contains the first-order differential value and the quadratic differential value that gradually decrease from the start point to the end point, the data processing module judging the locus configuration being a first curve and ordering the touch device to execute a first preset program corresponding to the first curve.

4. The method of claim 2, wherein at Step 3 the locus equation contains the first-order differential value which gradually increases from the start point to the end point and the quadratic differential value which gradually decreases from the start point to the end point, the data processing module judging the locus configuration being a second curve and ordering the touch device to execute a second preset program corresponding to the second curve.

5. The method of claim 2, wherein at Step 3 the locus equation contains the first-order differential value and the quadratic differential value that gradually increase from the start point to the end point, the data processing module judging the locus configuration being a third curve and ordering the touch device to execute a third preset program corresponding to the third curve.

6. The method of claim 2, wherein at Step 3 the locus equation contains the first-order differential value which gradually decreases from the start point to the end point and the quadratic differential value which gradually increases from the start point to the end point, the data processing module judging the locus configuration being a fourth curve and ordering the touch device to execute a fourth preset program corresponding to the fourth curve.

7. The method of claim 1, wherein at Step 2 the movement time ranges from 0.3 second to 0.6 second.

8. The method of claim 1, wherein at Step 1 the non-straight line locus is not continuous.

9. The method of claim 1, wherein at Step 3 the locus configuration is selected from the group consisting of a curve contained concave upward, a curve contained concave downward, a curve contained an inflection point and combinations thereof.

10. The method of claim 1, wherein the step S1 is preceded by a settled step in which the user draws on the touch display panel to form a settled line pattern to establish the corresponding locus configuration and a preset program corresponding to the locus configuration that requires activation.
